(19) United States
(12) Patent Application Publication
(10) Pub. No.: US 2003/0057192 A1
(43) Pub. Date: Mar. 27, 2003

(54) Method of laser controlled material processing

(75) Inventor: Rajesh S. Patel, Fremont, CA (US)

Correspondence Address: SUGHRUE MION, PLLC, 2100 Pennsylvania Avenue, NW, Washington, DC, 20037-3213, US

(73) Assignee: IMRA America, Inc.

(21) Appl. No.: 10/278,786

(22) Filed: Oct. 24, 2002

Related U.S. Application Data
(63) Continuation of application No. 09/779,652, filed on Feb. 9, 2001, now abandoned.

(51) Int. Cl. B23K 26/38; B23K 26/14

(52) U.S. Cl. 219/121.69

(57) ABSTRACT

A method for material processing using a pulsed laser includes generating a beam of laser pulses, focusing the beam in a plane above the surface of a workpiece, causing breakdown of matter at a lasing point, and removing or modifying material of the workpiece. Positioning the focal plane of the laser above the workpiece permits the use of higher intensity laser beam pulses and minimizes ill effects of workpiece surface conditions on laser energy absorption. In a second aspect, a method for material processing further includes using vacuum to remove the material removed by the beam, preferably by a push-pull type air vacuum system located slightly above the workpiece surface, thereby providing cleaner workpiece and feature surfaces.

### BACKGROUND OF THE INVENTION

1. Field of the Invention

The present invention relates to a method for material processing using a pulsed laser, where the material processing may include removal of material at the laser/material interaction site or may involve changing properties of a material at the laser material/interaction site. In particular the present invention relates to a method for material processing using a pulsed laser to remove material and leave a clean micromachined surface.

2. Description of the Related Art

Use of a laser to modify internal and external surfaces of materials is known from U.S. Pat. No. 5,656,186 (the '186 patent), entitled “Method for Controlling Configuration of Laser Induced Breakdown and Ablation,” issued Aug. 12, 1997 and assigned to the Regents of the University of Michigan, Ann Arbor, Mich.

The '186 patent discloses a relationship between fluence breakdown threshhold (Fₜₕ) and laser pulse beam width (T) that exhibits a distinct change in slope at a predetermined (characteristic) laser pulse width value. Above this characteristic pulse width value, the fluence breakdown threshhold (Fₜₕ) varies as the square root of the pulse width (T^{1/2}). However, this dependency is not exhibited at short pulse widths below the characteristic pulse width value.

The characteristic pulse width value corresponds to the point at which the thermal diffusion length (lₜₕ) becomes smaller than the absorption depth (l/a), where a is the absorption coefficient for the radiation. Namely, for pulse widths above the characteristic pulse width value, the thermal diffusion length is much longer than the absorption depth, resulting in thermal diffusion being the limiting factor for feature size resolution. However, for pulse widths below the characteristic pulse width value, the thermal diffusion length is smaller than the absorption depth such that thermal diffusion does not affect feature size resolution.

The '186 patent exploits this crossover, by providing a method for laser induced breakdown of a material with a pulsed laser in which the laser pulses have a pulse width equal to or less than the characteristic pulse width value, and focusing the pulsed laser beam to a point at or beneath the surface of the material.

However, the method disclosed in the '186 patent is not without potential shortcomings. For example, in order to reduce the feature size, laser beam intensity is adjusted to provide energies at or near the threshold for ablation. Specifically, laser beam intensity is adjusted such that in only a small fraction of the laser beam, e.g. the central portion of a gaussian beam, is the fluence greater than the ablation threshold, in order to restrict the ablated region to this limited area. In addition, the laser beam is focused to a point at or beneath the surface of the material, in order to control the damaged volume.

Accordingly, one potential shortcoming resulting from the prior art method is redeposition of the ablated material on the surface of the piece being machined. In view of the minimal energy imparted to the ablated material, the prior art method is likely to result in the redeposition of a substantial portion of the ablated material on or near the feature being lased. This poses two possible problems. First, the redeposited material may be difficult to remove after machining. Moreover, this contamination may act as scattering or absorbtion sites for the laser beam, causing roughness in future lasing. Specifically, the redeposited material may result in insufficient energy to remove material, given that the laser beam intensity is set right at or near the threshold fluence.

A second potential shortcoming of the prior art method is its inherent dependency on the surface conditions of the material being lased. The method of the '186 patent focuses the laser beam at or beneath the surface of the material. Consequently, the laser energy coupling during the first pulse depends on the initial surface condition of the material. Furthermore, laser energy coupling with the material may degrade during subsequent laser pulses because of the previously discussed ill effects of redeposited material. Accordingly, laser energy absorption may be reduced due to material surface conditions. Thus, the prior art method may result in both inefficient coupling of the laser beam energy into the material and undesirable roughness of surfaces of both the feature and workpiece.

### OBJECTS OF THE INVENTION

Accordingly, one object of the present invention is to provide a method for efficiently processing material using a pulsed laser that enhances the coupling of laser beam energy into the target material. According to a second object of the present invention, it is sought to provide a method for material processing using a pulsed laser that provides a cleaner workpiece surface, including providing a cleaner workpiece surface between pulses.

### SUMMARY OF THE INVENTION

The present invention achieves these and other objectives by providing a method for material processing using a pulsed laser. The method includes generating a beam of laser pulses, focusing the beam in a plane above a surface of a workpiece, causing breakdown of matter at a focused lasing point, and removing or modifying material of the workpiece. Preferably, the method includes generating a beam of laser pulses with pulse widths in the range of one nanosecond to one femtosecond (1×10⁻⁹−1×10⁻¹⁵ seconds) and positioning the focal plane at least 2 μm above the surface of the workpiece. More preferably, in practice the focal plane is positioned 2-10 μm above the surface of the workpiece.

A second embodiment further includes removing the material removed by lasing using vacuum. Preferably, the vacuum removal is performed by a push-pull type air vacuum system. More preferably, the vacuum system is located slightly above the workpiece surface.

### BRIEF DESCRIPTION OF THE DRAWINGS

The above objectives and advantages of the present invention will become more apparent by describing in detail preferred embodiments thereof with reference to the attached drawings, in which:

FIG. 1 is a schematic illustration of material processing using a pulsed laser according to a first embodiment of the present invention;

FIG. 2 is a schematic representation of material processing using a pulsed laser including vacuum removal of the material removed by lasing; and

FIG. 3 is a schematic illustration of a mask for projecting a plurality of laser beams onto a workpiece surface.

### DETAILED DESCRIPTION OF THE PREFERRED EMBODIMENTS

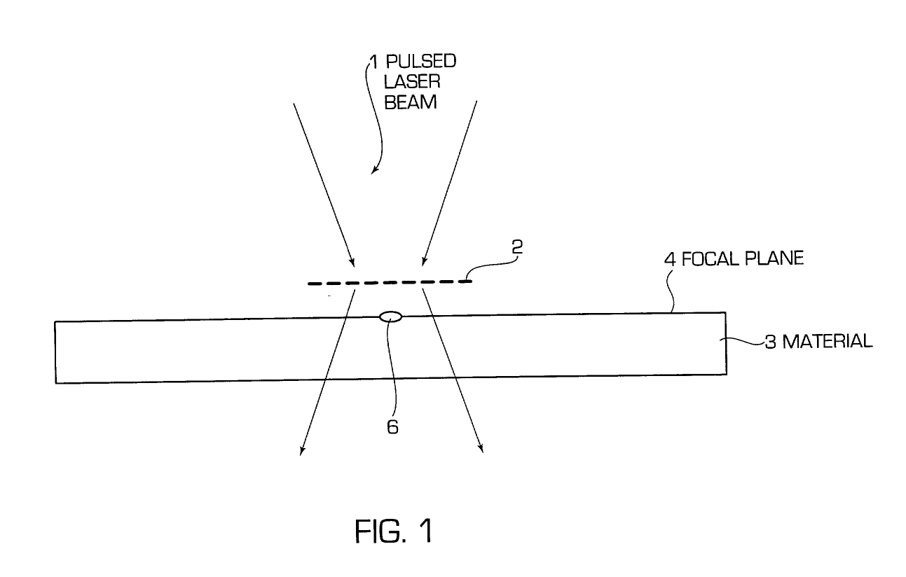

FIG. 1 illustrates a method for processing material using a pulsed laser according to the present invention. A pulsed laser beam 1 is focused in a plane 2 above a surface 4 of a workpiece 3 causing breakdown of matter at a focused lasing point 6. Examples of workpiece materials include, but are not limited to, metals and alloys, ceramics, transparent materials such as glass, quartz, sapphire, and diamond, organic materials such as polymide, and PMMA, and silicon.

Preferably, a beam 1 of laser pulses is generated with pulse widths in the range of one nanosecond to one femtosecond (1×10⁻⁹−1×10⁻¹⁵ seconds). Lasers capable of producing pulse widths within this range are known and include a Ti:Sapphire laser disclosed in the '186 patent. Such fast time scales are advantageous, in that at low energy levels, picosecond to femtosecond laser pulses can be used to effect nonequilibrium processes, without removing material from the lasing point 6. One example of a physical property that can be modified in this manner is crystal structure, e.g., going from a crystal to an amorphous structure.

More preferably, the laser beam intensity is adjusted such that the beam 1 has an intensity profile in its focal plane 2 having a small portion thereof greater than the fluence threshold such that only a corresponding portion of the intensity profile at the workpiece surface 4 is above the fluence threshold, where the corresponding portion of the intensity profile at the workpiece surface 4 is just barely above the threshold fluence.

The present invention positions the surface 4 of the workpiece 3 below the focal plane 2 of the laser beam 1. Preferably, the focal plane 2 is positioned a distance greater than a few microns above the workpiece surface 4. More preferably, the focal plane 2 of the laser beam is 2-10 microns above the workpiece surface 4. This configuration permits the use of higher intensity laser beam pulses because the beam intensity at the workpiece surface 4 will be lower. The laser beam intensity at the workpiece surface 4 can be calculated using well known formulas for beam intensity distributions.

Accordingly, the greater the distance between the focal plane 2 and the workpiece 3, the greater the laser beam intensity must be at the focal plane 2, in order to remove or modify material from the workpiece 3. However, by increasing the distance between the focal plane 2 and the workpiece 3, the intensity distribution of the laser beam 1 at the workpiece surface 4 is broadened. As is known from the '186 patent, the beam intensity should be adjusted such that only a small fraction of the beam profile at the lasing point should have energies above the fluence threshold, in order to achieve precision machining. Thus, the focal plane 2 cannot be positioned too far above the workpiece surface 4, or else precision machining cannot be achieved. Accordingly, when small feature sizes are required (i.e., considerably smaller than the spot size), the distance between the focal plane 2 and the workpiece surface 4 should be small.

A range of distances between the focal plane 2 of the laser beam and the workpiece 3 provides precision machining with clean workpiece and feature surfaces, by operating a laser beam 1 under the following conditions. First, the focal plane 2 is preferably positioned a distance greater than a few microns above the workpiece surface 4. More preferably, the focal plane 2 of the laser beam is positioned 2-10 microns above the workpiece surface 4. In addition, the laser pulses preferably have pulse widths in the range of one nanosecond to one femtosecond (1×10⁻⁹−1×10⁻¹⁵ seconds). Further, the beam energy per pulse is preferably greater than one nanojoule (1×10⁻⁹ Joule).

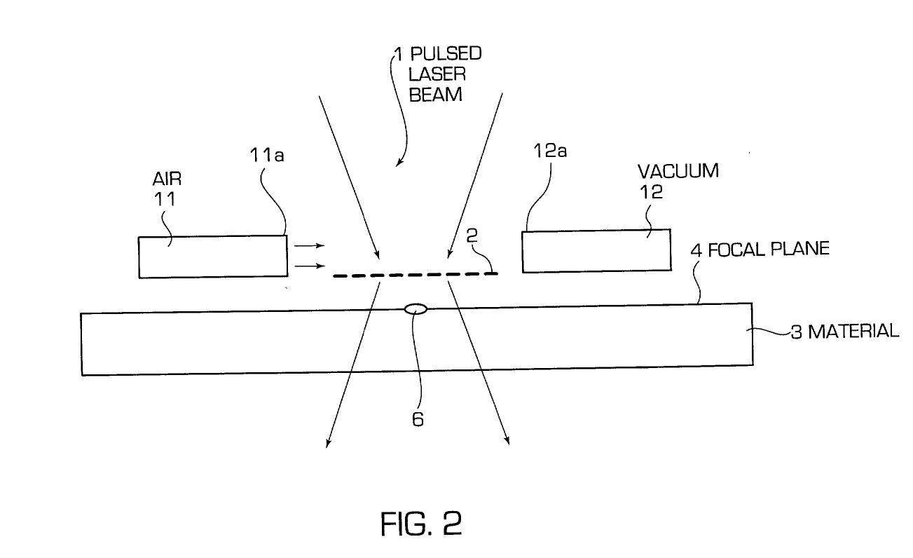

A second embodiment of the present invention is shown in FIG. 2. A pulsed laser beam 1 is focused in a plane above a surface 4 of a workpiece 3 causing breakdown of matter at a lasing point 6. Material removed from the workpiece 3 is then removed by vacuum. By removing the material by vacuum, the redeposition of a substantial portion of the ablated material on or near the feature being lased 6 can be avoided. In this manner, cleaner workpiece and feature surfaces are provided.

Preferably, the vacuum removal is performed by a push-pull type air vacuum system, which is located slightly above the workpiece surface 4. It is preferable to position the vacuum system and workpiece surface 4 as close as is possible without physically damaging the workpiece surface 4. Preferably, the vacuum system and the workpiece surface 4 are separated by a distance of a few millimeters, and more preferably, by 2-10 millimeters.

A push-pull type air vacuum system is illustrated schematically in FIG. 2. Air is supplied by an air supply manifold 11, which supplies compressed air, thereby pushing the removed material toward a vacuum manifold 12, which sucks the debris away from the feature being lased 6, thereby providing cleaner workpiece and feature surfaces. Such systems are well known in the art, and consequently, will not be described in detail.

In order to achieve maximal cleaning of the laser-material interaction area, the compressed air pressure and vacuum pressure are preferably adjusted for a given set of material and laser processing parameters. Furthermore, an end 111 a of the air supply manifold 11 can be designed to supply air at an angle (not shown) to the workpiece 3. In addition, a nozzle or comparable structural feature (not shown) can be attached to the end 11a of the air supply manifold 11 to create a jet or multiple jets of air, in order to enhance debris removal. Moreover, an end 12a of the vacuum manifold 12 is preferably configured such that the maximum amount of debris lifted away by the compressed air can be trapped and carried away from the laser-material interaction area.

This method of material processing is advantageous in that, by focusing the laser beam above the workpiece surface 4, the various ill effects of material surface conditions on the laser energy absorption are minimized. In addition, use of a push-pull type air vacuum system provides a cleaner workpiece surface for subsequent laser pulses. Thus overall, the present method avoids direct interaction of the most intense portion of the laser beam with the workpiece surface 4, thereby utilizing laser energy more efficiently.

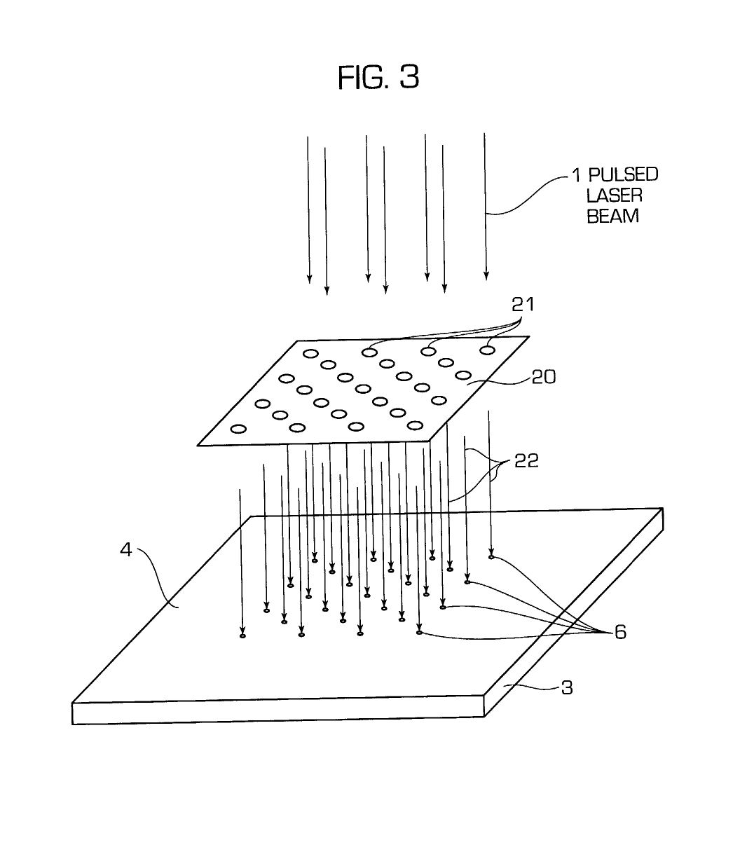

A third embodiment of the present invention is illustrated in FIG. 3. A pulsed laser beam 1 is projected through a mask 20, which is positioned between a laser pulse source (not shown) and a workpiece 3. The mask 20 includes a plurality of openings 21 through which a plurality of beams 22 are formed. Mask projection techniques are known and thus are not discussed in more detail. The plurality of beams 22 are focused in a focal plane above a surface 4 of the workpiece 3, causing breakdown of matter at a plurality of lasing points 6 and removal or modification of the material of the workpiece 3.

The above description of the preferred embodiments has been given by way of example. From the disclosure given, those skilled in the art will not only understand the present invention and its attendant advantages, but will also find apparent various changes and modifications to the structures disclosed. It is sought, therefore, to cover all such changes and modifications as fall within the spirit and scope of the invention, as defined by the appended claims, and equivalents thereof.

What is claimed:

1. A method for material processing using a pulsed laser comprising:
generating a beam of laser pulses;
focusing said beam in a focal plane above a surface of a workpiece;
causing breakdown of matter at a lasing point; and
removing or modifying material of the workpiece by said beam.

2. The method of claim 1, wherein said focal plane is at least 2 μm above the surface of the workpiece.

3. The method of claim 2, wherein said focal plane is 2-10 μm above the surface of the workpiece.

4. The method of claim 1, wherein the workpiece material is a metal or an alloy.

5. The method of claim 1, wherein the workpiece material is glass, quartz, sapphire, or diamond.

6. The method of claim 1, wherein the workpiece material comprises an organic material.

7. The method of claim 1, wherein the workpiece material comprises silicon.

8. The method of claim 1, wherein said beam has a pulse energy greater than one nanojoule.

9. The method of claim 1, further comprising:
setting a laser pulse width in a range of one nanosecond to one femtosecond.

10. The method of claim 1, further comprising:
removing material removed from the workpiece by said beam by vacuum.

11. The method of claim 10, wherein a push-pull type vacuum system removes the material removed from the workpiece by said beam.

12. The method of claim 1, wherein said push-pull type vacuum system comprises an air supply manifold, producing at least one jet of air, and a vacuum manifold.

13. The method of claim 11, wherein said push-pull type vacuum system is located 2-10 mm above the workpiece surface.

14. A method for material processing using a pulsed laser comprising:
generating a beam of laser pulses;
projecting the beam through a mask, which is positioned between a laser pulse source and a workpiece and comprises a plurality of openings to form a plurality of beams;
focusing the plurality of beams in a focal plane above a surface of the workpiece;
causing breakdown of matter at a plurality of lasing points; and
removing or modifying material of the workpiece by the plurality of beams.
